(19) United States
(12) Patent Application Publication
(10) Pub. No.: US 2021/0078115 A1
(43) Pub. Date: Mar. 18, 2021

(54) TORCH BODY FOR THERMAL JOINING

(71) Applicant: ALEXANDER BINZEL SCHWEISSTECHNIK GMBH & CO. KG, Buseck (DE)

(72) Inventors: Sascha ROSE, Fernwald (DE); Eckhard KRÄMER, Buseck (DE); Ralf SCHÄFFER, Wettenberg (DE)

(73) Assignee: Alexander Binzel Schweisstechnik GmbH & Co. KG, Buseck (DE)

(21) Appl. No.: 16/643,871

(22) PCT Filed: Sep. 7, 2018
(86) PCT No.: PCT/EP2018/074096

§ 371 Date: Mar. 3, 2020

(30) Foreign Application Priority Data
Sep. 19, 2017 (DE) 10 2017 121 722.3

(51) Int. Cl. B23K 37/02; B23K 9/28; B23K 9/32

(52) U.S. Cl. CPC B23K 37/0211; B23K 9/285; B23K 9/164; B23K 37/0241; B23K 9/325

(57) ABSTRACT

The invention relates a torch body for thermal joining of at least one workpiece, in particular for arc welding or arc brazing, said torch body comprising a non-consumable electrode provided in the body, in particular a tungsten electrode, for generating an arc between the electrode and the workpiece. The torch body has an end nozzle, which is devoid of potential, for discharging a shielding gas flow from a gas outlet. A secondary flow channel is provided for dividing the shielding gas flow into a main gas flow and a secondary gas flow, the secondary gas flow annularly surrounding the main gas flow at the gas outlet.

### CROSS-REFERENCE TO RELATED APPLICATIONS

This application is a national stage application (under 35 USC § 371) of PCT/EP2018/074096, filed Sep. 7, 2018, claiming priority to DE 10 2017 121 722.3, filed Sep. 19, 2017, the contents of each of which are incorporated by reference herein.

### BACKGROUND OF THE INVENTION

### Technical Field and State of the Art

The invention relates to a torch body as well as to a torch having such a torch body and to a method for thermally joining at least one workpiece, especially for arc welding or arc soldering. Furthermore, the invention relates to a joining device.

Thermal joining methods utilize energy to melt down the workpieces and to join them. “MIG”, “MAG” and “TIG” are standard welding methods that are employed in sheet metal processing.

When it comes to shielding gas-assisted arc welding methods employing a consumable electrode (MSG), “MIG” stands for “metal inert gas” and “MAG” stands for “metal active gas”. In the case of shielding gas-assisted arc welding methods employing a non-consumable electrode (TSG), “TIG” stands for “tungsten inert gas”. The welding devices according to the invention can be configured as machine-controlled welding torches.

Arc welding devices generate an arc between the workpiece and a consumable or non-consumable welding electrode in order to melt down the material that is to be welded. A shielding gas stream shields the material that is to be welded as well as the welding site against the atmospheric gases, mainly N₂, O₂, H₂ that are present in the ambient air.

In this context, the welding electrode is provided on a torch body of a welding torch that is connected to an arc welding device. The torch body normally has a group of internal components that carry current and that conduct the welding current from a source of welding current in the arc welding device to the tip of the torch head and to the welding electrode, where it then generates the arc to the workpiece.

The shielding gas stream flows around the welding electrode, the arc, the welding bath and the heat-affected zone on the workpiece, and in this process, it is fed to these areas via the body of the welding torch. A gas nozzle conducts the shielding gas stream to the front end of the torch head, where the shielding gas stream exits from the torch head around the welding electrode in an approximately annular pattern.

During the welding procedure, the arc generated for the welding heats up the workpiece that is to be welded as well as any optionally added welding material, so that these are melted down. The input of arc energy, the high-energy heat radiation and convection all give rise to a significant input of heat into the head of the welding torch. Some of the introduced heat can be dissipated again into the hose pack by the shielding gas stream that is conveyed through the torch head or by the passive cooling in the ambient air as well as by heat conduction.

However, above a certain welding current load of the torch head, the heat input is so high that so-called active cooling of the torch head is necessary in order to protect the employed components against thermal material failure. Towards this end, the torch head is actively cooled with a coolant that flows through the torch head, thereby carrying away the unwanted heat that has been picked up during the welding process. For example, de-ionized water to which ethanol or propanol has been added can be employed as a coolant for purposes of providing protection against freezing.

Aside from welding, soldering is also an option when it comes to joining sheet metal components. Unlike in the case of welding, with soldering, it is not the workpiece that is melted but rather only the filler material. The reason is that, in the case of soldering, two edges are joined together by the solder as the filler material. The melting temperatures of the solder material and of the component materials are very different, which is why only the solder melts during processing. Aside from TIG torches, plasma torches and MIG torches, lasers are also suitable for soldering.

The arc soldering processes can be broken down into metal shielding gas soldering (MIG-S) processes and tungsten-shielding gas soldering (TIG-S) processes. Here, copper-based materials in wire form, whose melting ranges are lower than those of the base materials, are predominantly used as the filler material. In terms of the equipment employed, the principle of MSG arc soldering is largely identical to MSG welding, using filler material in wire form. In the case of TIG soldering, the filler material in wire form is fed into the arc either manually or mechanically from the side. In this process, the filler material can be fed in either without current as a cold wire or else with current as a hot wire. Greater melting capacities are achieved with a hot wire although the arc is influenced by the additional magnetic field.

As a rule, arc soldering is used on surface-finished or uncoated thin-gauge sheet metal since, among other things, the lower melting temperature of the solder in comparison to welding accounts for less thermal stress for the components, and the coating is only damaged to a lesser extent. No appreciable melting of the base material occurs in the case of arc soldering.

The arc soldering processes are normally employed on uncoated and metal-coated sheet metal made of unalloyed or low-alloyed steel within the thickness range of up to approximately 3 mm at the maximum.

Usually, argon II or argon mixtures with admixtures of CO₂, O₂ or H₂ according to DIN ISO 14175 are used for arc soldering. Commercially available TIG torches can be employed for TIG soldering.

The state of the art discloses arc processes with modified TIG torches in order to provide concentrated arcs for high-speed soldering applications. Drawbacks of the prior-art torches include the need to use special electrodes, the limited tool life of the electrode and the inadequate ease of maintenance due to open cooling circuits and complicated electrode settings.

European patent specification EP 2008 750 B1 discloses a tungsten inert gas torch that has a housing cylinder with an upper lid closure, whereby at least one feed line and a return line for coolant as well as an inert gas line and an electric connection for the operation of a tungsten electrode all pass through said upper lid closure.

Furthermore, there is an elongated cooling element that is situated inside the housing cylinder and that contains an elongated cavity that is open on the upper end face of the cooling element, and there is also an interior lid closure located on top of it, whereby the lines for the coolant run through said lid closure. On the lower end face of the cooling element along the axis of the torch head, there is a recessed threaded hole which has a cylindrical tungsten electrode body that is provided with a sharpened tip whose end is arranged at a prescribed distance from the lower end face of the cooling element.

The welding torch also comprises a gas nozzle which is connected to the elongated cooling element while incorporating lengthwise channels and which surrounds the cooling element and the electrode.

European patent application EP 2 894 005 A1, international patent application WO 2015/105567 A1 and U.S. Pat. Appln. No. 2016/0221127 A1 disclose an electrode and a welding torch arrangement having such an electrode. In this context, the electrode comprises an elongated body that defines a longitudinal axis as well as a tip end section with a first truncated cone and a working end section with a second truncated cone, whereby the elongated body is situated between the tip end section and the working end section. The welding torch has a setting rail affixed to a mounting plate as well as an adjustment element that can be slid relative to the adjustment track, a torch body, an electrode holder having a longitudinal axis and a retaining nut that secures the electrode in the electrode holder. The electrode retaining nut touches the angled surface of the tip end section.

European patent application EP 0 962 277 A1 discloses a plasma welding torch that has a chamber in which a non-consumable electrode is arranged that is connected to a source of direct current. The chamber is fitted with an outlet channel and an inlet channel for a plasma gas. The electrode has a free end section. The free end of the tip of the electrode is flattened and it protrudes from the free end face of the opening part. Moreover, the head area of the opening part has additional channels that concentrically surround the conical outlet channel.

The outlet channel is surrounded by additional channels provided for conveying cold plasma gas. The plasma gas flowing out of the outlet channel is supposed to compress or constrict the plasma jet outside of the outlet channel. The plasma gas flows essentially along a conical surface that has a given wall thickness.

Drawbacks of the prior-art torches include the need to use special electrodes, the limited tool life of the electrodes and the inadequate ease of maintenance due to open cooling circuits and complicated electrode settings.

Moreover, the soldering of galvanized sheet metal, for example, in precisely timed manufacturing operations in the automotive industry, limits the service life of the electrode due to its being alloyed, thus giving rise to detrimental effects on processes and necessitating frequent maintenance.

Before the backdrop of the drawbacks described above, the industry seeks an improved torch body that has a simple, cost-effective and compact structure and that concurrently ensures protection of the electrode against zinc vapor, while also providing a concentrated arc for short arc lengths.

### SUMMARY OF THE INVENTION

According to an embodiment of the invention, a torch body for thermally joining at least one workpiece is being put forward, especially for arc welding or arc soldering, having a non-consumable electrode, particularly a tungsten electrode, arranged in the torch body for generating an arc between the electrode and the workpiece. Furthermore, a potential-free front nozzle is provided so that a shielding gas stream can flow out of a gas outlet.

According to the invention, the front nozzle has at least one secondary flow channel to divide the shielding gas stream into a main gas flow and into a secondary gas flow. Moreover, according to the invention, the secondary gas flow surrounds the main gas flow at the gas outlet in an annular pattern.

As mentioned above, when it comes to TIG welding, an arc burns freely between a non-consumable electrode—which as a rule, is cathodically polarized—and the workpiece. This welding process is protected by a stream of shielding gas. The shielding gas can contain argon or helium or else a mixture of both as its main component.

The invention is characterized in that, thanks to the combination of a minimal installation size and the division of the gas stream into two flows, it is achieved that, especially in comparison to other torch types such as, for instance, plasma torches, there is no need to provide additional space for a second gas flow in the torch or to provide isolation for another electric potential. Moreover, a conventional TIG source of current can be used, as a result of which the cost effectiveness of the torch device is further increased.

The secondary gas flow provided in addition to the main gas flow allows for a large heat-conducting cross section of the front nozzle as compared to the torch bodies known from the state of the art. The secondary flow channels enlarge the surface area covered by the shielding gas stream. Consequently, the front nozzle not only fulfills a protective function for the electrode against zinc vaporization, but also ensures good cooling in the processing area.

According to a first advantageous embodiment of the invention, it can be provided for several secondary flow channels to be arranged along the circumference of the front nozzle, preferably at an opening angle of 10° to 30° directed outwards relative to the longitudinal axis of the front nozzle. The outwards directed secondary flow channels further enlarge the surface area covered by the stream of shielding gas.

According to another preferred embodiment of the invention, it can be provided for the electrode to form the distal end of the torch body facing the workpiece or else for it to be approximately flush with the distal end. This accounts for an optimal ignition of the arc.

As an alternative, the front nozzle can form the distal end of the torch body facing the workpiece, and the electrode can be recessed relative to this end, especially by about 0.5 mm to 1.5 mm.

In a particularly advantageous refinement of the invention, the electrode has an essentially cylindrical section and/or a sharpened end facing the workpiece. The sharpened end of the electrode can have a torch angle of 20° to 45°, preferably 30°. The end of the electrode facing the workpiece can have a truncated cone plateau with a diameter of 0.5 mm to 1.5 mm, preferably 1.0 mm. Since the arc is formed between the workpiece and the electrode, the geometric shape of the electrode tip facing the workpiece is decisive for the dimension and shape of the arc as well as for the ignition of the torch. For this reason, a plateau is provided on this electrode end so that, in this area, the arc runs essentially perpendicularly and rectilinearly from the electrode to the workpiece. The effect of the arc is thus further optimized in the processing area.

In a refinement of the invention, a cooling element is provided that serves to cool the torch body, in particular, the cooling element has cooling channels for conveying a coolant. Active cooling of the torch head is necessary in order to protect the employed components against thermal material failure. For this purpose, the torch head is actively cooled with a coolant that flows through the torch head and carries away the unwanted heat picked up from the welding process. As mentioned above, de-ionized water to which ethanol or propanol has been added can be employed as a coolant for purposes of providing protection against freezing. As an alternative, it is likewise possible to convey the shielding gas or air as a coolant through the cooling channels.

According to another advantageous embodiment, the front nozzle is configured in two parts. As set forth in the invention, it is also conceivable for the front nozzle 3 to be configured in one piece. According to the invention, the front nozzle comprises a center nozzle and a gas nozzle. The configuration of the front nozzle with a center nozzle and with a gas nozzle achieves, on the one hand, that the structure is more compact and, on the other hand, that both nozzles each have a relatively small diameter for the channels that serve to convey the shielding gas streams. In this manner, the torch body can be designed to be considerably thinner in the front area, that is to say, where it faces the workpiece.

The center nozzle can be made of copper or of a copper alloy in order to ensure very high thermal conduction and/or the gas nozzle can be made of brass or of a brass alloy so as to achieve high thermal conduction as well as high strength at the same time. As an alternative, the gas nozzle can also be made of ceramic.

In a refinement of the invention, an internal electric isolator isolates the front nozzle from the electrode.

Additional isolation, so-called external isolation, can be provided so that the components of the welding torch that are accessible from the outside, particularly the torch body, the so-called potential-free components, are electrically isolated from the non-isolated components inside the welding torch so that the fact that they are de-energized ensures protection against electric shock in case of contact as well as protection of other machinery and devices. Moreover, this measure prevents the arc from drifting away from the welding electrode. Drifting of the arc away from the welding electrode in conventional arc welding devices can cause the arc to jump over to the gas nozzle or to the torch neck protection tube and to melt it. This can prematurely render the part in question unusable and necessitate its replacement.

According to an advantageous embodiment of the invention, an annular gap for equalizing and guiding the secondary gas flow can be formed between the center nozzle and the gas nozzle. In particular, it can be provided for the gas nozzle to at least partially overlap the center nozzle at the end of the outlet opening of the secondary flow channels in order to form the annular gap over the circumference. This ensures further improved coverage with the shielding gas for the seam as well as in the processing area. This further improves the function of protecting the electrode against zinc vaporization. Moreover, this translates into optimal thermal conduction and heat transfer to the torch body. At the same time, the structure of the torch body is rendered even more compact.

In an especially advantageous variant of the invention, the center nozzle has the secondary flow channels. As a result, the front section of the torch body is more compact. Optimal cooling of the torch body is achieved by means of the secondary flow channels, which are preferably situated at the height of a contact surface of the center nozzle, as a result of which the nozzle tip is free of drilled holes or channels, so that it is configured to be thin and compact in order to make the components easily accessible.

According to an embodiment of the invention, it can be provided for the center nozzle to have an outlet opening with a cross section of about 5 mm² to 22 mm², especially about 12.5 mm² to 15.9 mm², whereby the cross section of the outlet opening is smaller than or equal to the cross section of the electrode in the area of the cylindrical section of the electrode, thus ensuring uniform outflows at the sharpened electrode.

According to a preferred embodiment of the invention, it can be provided for the sum of the cross sections of the secondary flow channels of the center nozzle to be approximately 12 mm² to 22 mm², particularly approximately 20 mm², thus ensuring a uniform distribution of the volume flows between the secondary gas flow and the main gas flow.

In another advantageous embodiment of the invention, the ratio of the cross section of the outlet opening to the sum of the cross sections of the secondary flow channels is somewhat similar, preferably approximately 4:5. For this reason, the constricting effect of the gas nozzle is relatively small. Instead, it especially fulfills the function of protecting the electrode against rising zinc vapor, particularly during soldering of galvanized sheet metal.

In another advantageous embodiment of the invention, the gas nozzle is configured as a fastening nut so that it can be coupled to the center nozzle. This significantly simplifies the installation of the nozzle. Moreover, it also becomes very easy to replace the center nozzle since the gas nozzle, which acts as a fastening nut or as a union nut and which can have an internal thread, is pulled over the center nozzle during replacement and is then connected to the torch body by means of a mating external thread on the latter. When the center nozzle is replaced, for example, if the nozzle is defective or worn out, the gas nozzle is loosened by means of the thread and removed, so that the center nozzle that is to be replaced can very easily be taken out of the torch body. In order to facilitate the removal, the annular surface of the center nozzle can be provided with additional spanner flats. Once a new center nozzle has been inserted into the body, the gas nozzle is screwed back onto the thread of the torch body and secured. As a result, the center nozzle is pressed into the conical seat of the torch body and optimal heat transfer is achieved.

According to a first independent idea of the invention, a torch having a torch body according to the invention is provided.

In another independent idea of the invention, a method is described for thermally joining at least one workpiece, especially for arc welding or arc soldering, with a non-consumable electrode for generating an arc between the electrode and the workpiece. Moreover, a shielding gas stream is provided that flows out of a potential-free front nozzle. The shielding gas stream is divided into a main gas flow that directly surrounds the electrode and a secondary gas flow that exits from the front end of the torch body, whereby the secondary gas flow surrounds the main gas flow at the gas outlet in an annular pattern.

In another independent idea of the invention, a joining device for thermally joining at least one workpiece, especially for arc welding or arc soldering, is being put forward. The joining device has a machine-controlled torch for generating an arc between a non-consumable electrode arranged therein, especially a tungsten electrode, and the workpiece. Moreover, the joining device can have a torch body as described above.

Furthermore, the joining device according to the invention has a torch changing device for replacing the torch with a new torch as well as a tactile seam tracking system. A position transducer is arranged so as to be movable relative to the workpiece and so as to be at a certain distance from the torch, whereby the torch is coupled to the tactile seam tracking system.

According to the invention, a movement relative to the position transducer can move the torch into at least one working position for thermally joining the workpiece and into a replacement position for replacing the torch with a new torch.

The torch can be replaced in order to optimize the processing times and to minimize idle times of the torch, although conceivably only the spent or defective electrode and/or the nozzle of the torch would have to be replaced.

Owing to the application of force onto the filler material during concurrent heat-induced softening of the filler material, the free end of the wire should be kept as short as possible, as a result of which the position transducer of the thermal joining device, which is normally configured so as not to be movable, is arranged very close to the front end of the torch. As a rule, this distance is just a few millimeters. For this reason, the torch and the position transducer might collide when the torch is being changed, either manually or automatically. Since the position transducer can have an outlet opening through which a filler material for welding or soldering can be placed in the immediate vicinity of the torch head, the torch and the filler material might also collide, for instance, due to a filler wire that has not been retracted completely. Such collisions can damage the torch and/or the tactile seam tracking system.

Replacing the torch is advantageous in comparison to manually replacing the electrode or other torch components such as, for example, the front nozzle, because then neither the front nozzle nor the electrode have to be manually removed and replaced. In contrast, the torch is replaced along with the electrode and the nozzle, as a result of which there is less downtime of the thermal joining device.

For instance, a cartridge can be provided which contains a plurality of new torches which can be deployed as needed by means of an automated or manual method for changing a defective or spent torch, such as, for example, a gripper arm that uses a coupling device that can be coupled onto the torch and can transport it in this manner.

In addition, the tactile seam tracking system can also be fitted with another device to feed shielding gas in the direction of the torch.

Moreover, via a control unit, the position transducer can relay the momentary position of the sensor—which is installed at the front end of the transducer and which moves along the joining site of the workpiece that is to be joined—to actuators that control the movement of the joining device. The joining device itself can have additional actuators that, in comparison to a robot control system, can execute a more precise movement of the tactile seam tracking system.

In the working position, the tactile seam tracking system moves along a seam that is to be welded or soldered. The torch moves at a short distance thereto and “follows” the seam tracking system. This defines a prescribed working direction in which the end of the torch is in the immediate vicinity of the tactile seam tracking system and follows it.

In the replacement position, the distance between the torch and the seam tracking system, especially along the working direction, is increased in that the torch is moved away from the seam tracking system counter to the working direction.

As soon as the distance between the torch and the tactile seam tracking system has increased, the torch that is to be replaced can be removed and replaced with a new torch. Means are provided such as, for instance, the gripper arms of a robot, so that the spent torch that is to be replaced can be uncoupled from the source of welding energy, especially from the lines for the shielding gas, for the electric energy and for the coolant. Then the torch is moved away from the tactile seam tracking system, for example, approximately in parallel to the longitudinal direction of the torch towards a changer, so that it can ultimately be removed without colliding with the seam tracking system.

In a first advantageous refinement of the invention, in order to replace the torch with a new torch, a movable carriage is provided for positioning the torch that has been coupled to the carriage. In order to prevent the torch and the position transducer or the tactile seam tracking system from colliding, the torch is moved by means of the carriage in the direction of the changer and thus away from the position transducer or from the tactile seam tracking system. The carriage is necessary since the feed device for the filler material and a seam sensor of the tactile seam tracking system are arranged rigidly, that is to say, immovably, relative to the torch, so that this feed device is essentially in the way during the replacement procedure of the torch and, due to the very short distance to the torch, it might cause the torch and/or to the tactile seam tracking system to collide and be damaged.

In a refinement of the invention, the carriage is powered electrically, pneumatically or hydraulically, so that precise control of the carriage is ensured.

In another variant of the invention, the carriage has a torch holder for holding the torch and/or a coupling device for feeding the welding energy. This welding energy comprises, among other things, electric energy and feed lines for the coolant as well as for the shielding gas. When the torch is replaced, the appertaining couplers for connecting the lines that convey the welding energy through the torch body have to be easy to latch and unlatch, so that the torch can be replaced quickly, neatly and safely.

According to a preferred embodiment of the invention, the torch is locked at least in the working position. In order to attain a very high precision of the welding or soldering processes, the control means has to allow the appertaining positions of the torch to be approached very precisely. In order to prevent imprecisions, the torch is locked at least in the working position. Moreover, as set forth in the invention, it is likewise conceivable that the torch can be locked in other positions, for example, in the replacement position.

In an advantageous embodiment of the invention, the torch can be moved exclusively between the working position and the replacement position and vice versa. This also enhances the precision of the joining device. Moreover, the clock frequency of the device is increased. After all, since only two positions are approached, malfunctions and thus downtimes of the device can be reduced. These two positions can be configured as stable positions.

In another advantageous embodiment of the invention, the seam tracking system has an outlet opening, which is especially arranged on the position transducer, whereby the filler material for arc soldering or arc welding can be dispensed through this opening. The filler material can be, for instance, welding wire or soldering wire. Therefore, the seam tracking system fulfills a dual function. On the one hand, it dispenses the filler material and, on the other hand, it serves as a tactile measuring system.

According to a preferred embodiment of the invention, a distal end of the tactile seam tracking system is arranged in the immediate vicinity of the front end of the torch. This translates into a very compact design for the device.

Additional objectives, advantages, features and application possibilities of the present invention can be gleaned from the description below of an embodiment making reference to the drawing. In this context, all of the described and/or depicted features, either on their own or in any meaningful combination, constitute the subject matter of the present invention, also irrespective of their compilation in the claims or in the claims to which they refer back.

### DESCRIPTION OF THE DRAWINGS

In this context, the following is shown, at times schematically:

FIG. 1 a torch body for thermally joining at least one workpiece, comprising a center nozzle and a gas nozzle;

FIG. 2 detailed views of the torch body in a top view (a), a side view (b) and as a cutaway drawing (c);

FIG. 3 detailed views of the center nozzle in a top view (a), a side view (b) and as a cutaway drawing (c);

FIG. 4 detailed views of the gas nozzle in a top view (a), a side view (b) and as a cutaway drawing (c);

FIG. 5a a schematic depiction of a joining device in the working position in a first side view;

FIG. 5b a schematic depiction of a joining device in the working position in another side view;

FIG. 6 a schematic depiction of the joining device in the replacement position; and

FIG. 7 a schematic depiction of the joining device with the torch removed.

### DETAILED DESCRIPTION

For the sake of clarity, identical components or those having the same effect are provided with the same reference numerals in the figures shown below, making reference to an embodiment.

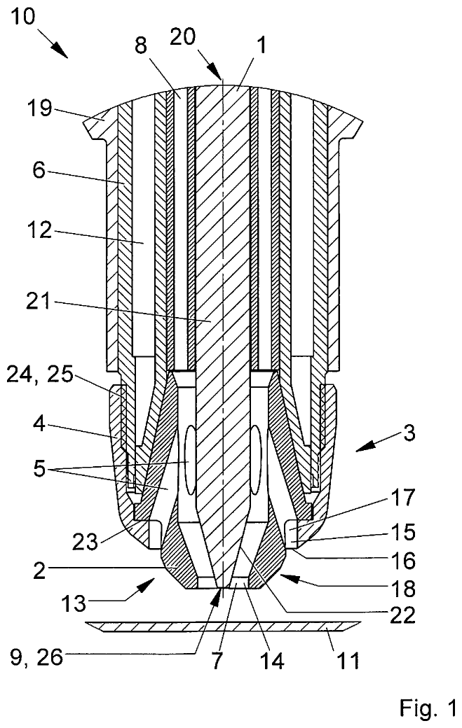

FIG. 1 shows a torch body 10 for thermally joining at least one workpiece 11, especially for arc welding or arc soldering, with a non-consumable electrode 1 arranged in the torch body 10, especially a tungsten electrode, for generating an arc between the electrode 1 and the workpiece 11.

In the present embodiment of the invention, the electrode 1 is approximately flush with the torch body 10, that is to say, it forms its front end 18 together with the other components of the torch body 10. Within the scope of the invention, it can also be provided for the electrode 1 to form the distal end 9 of the torch body 10 facing the workpiece 11 and for it to project beyond the other components of the torch body towards the front end 18. As an alternative, it would also be conceivable for at least part of a nozzle that forms the distal end 9 of the torch body 10 facing the workpiece 11 and for the electrode 1 to be recessed relative to this end 9, particularly by approximately 0.5 mm to 1.5 mm.

The electrode 1 can have an essentially cylindrical section 21 and/or a sharpened end 22 facing the workpiece.

As is shown in FIG. 1, a front nozzle 3 is provided that is electrically potential-disconnected or potential-free by means of an internal isolator 8 and that allows a shielding gas stream to flow out of a gas outlet 13 of the torch. The internal isolator 8 can be made, for example, of a ceramic material or it can contain ceramic material.

As can also be seen in FIG. 1, external isolation 19 is provided so that the parts of the torch that can be accessed by the user from the outside can be electrically isolated from the non-isolated components in the interior of the welding torch. Moreover, this external isolation 19 prevents the arc from drifting away from the electrode 1.

The front nozzle 3 has at least one secondary flow channel 5 to divide the shielding gas stream into a main gas flow 14 and into secondary gas flow 15. Moreover, the secondary gas flow 15 surrounds the main gas flow 14 at the gas outlet 13 in an annular pattern. The shielding gas can contain argon or helium or else a mixture of both as its main component. In addition, small admixtures of oxygen, carbon dioxide and/or hydrogen are possible as secondary constituents.

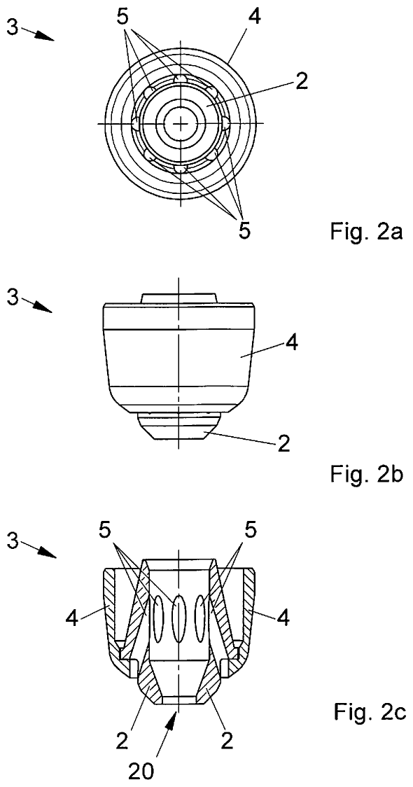

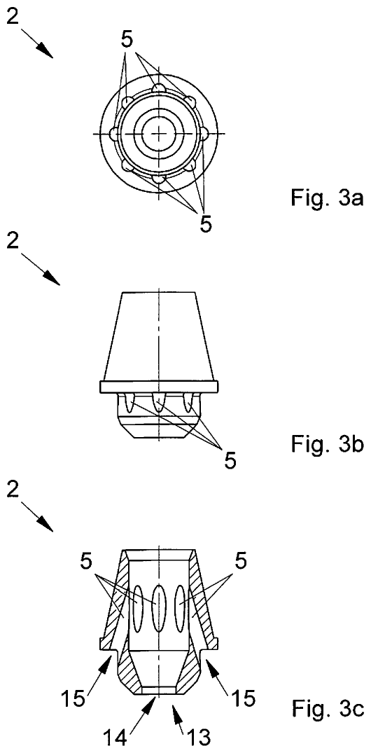

As can be gleaned from FIG. 1 as well as FIGS. 2a to 2c and 3a to 3c, several secondary flow channels 5 are arranged along the circumference of the front nozzle 3, preferably at an opening angle of 10° to 30° directed outwards relative to the longitudinal axis 20 of the front nozzle 3.

FIG. 1 shows a cooling element 6 for cooling the torch body 10 that, in this case, has cooling channels 12 to convey a coolant. It can also be provided that a portion of the shielding gas stream is passed through these channels 12 in order to cool the torch body 10.

FIGS. 1 and 2 show that the front nozzle 3 in the present embodiment is configured in two parts and it comprises a center nozzle 2 and a gas nozzle 4. As set forth in the invention, it is also conceivable for the front nozzle 3 to be configured in one piece.

FIGS. 3a to 3c show detailed views of the center nozzle 2. FIG. 3a shows a top view, FIG. 3b shows a side view and FIG. 3c shows a cutaway view of the center nozzle 2. The main gas flow 14 of the shielding gas stream exits through an internal outlet opening 7 of the center nozzle 2.

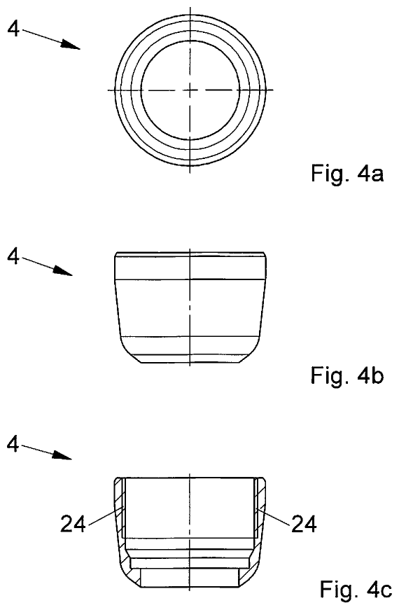

FIGS. 4a to 4c show analogous views of the gas nozzle 4.

An annular gap 17 for equalizing and guiding the secondary gas flow is formed between the center nozzle 2 and the gas nozzle 4. As can be seen in FIGS. 2a to 2c, the gas nozzle 4 overlaps the center nozzle 2 at the end of the external outlet opening 16 of the secondary flow channels 5 in order to form the annular gap 17 along the circumference, at least partially.

The shielding gas exits from the annular gap 17 at the center nozzle 2. The secondary flow channels 5 open up into the outer outlet openings 16. The center nozzle 2 has an annular surface 23 so that the center nozzle 2 can be secured with a positive fit in the axial direction on the torch body 10. The annular surface 23 can be additionally provided with spanner flats to facilitate the removal from the conical press fit of the torch body. The individual discrete secondary flow channels 5 open up into the annular gap 17 approximately at the height of the annular surface 23 and exit from it in the direction of the workpiece 11.

The center nozzle 2 can be made of copper or of a copper alloy and/or the gas nozzle 4 can be made of brass or of a brass alloy.

It can also be gleaned from FIGS. 4a to 4c that the gas nozzle 4 can be configured as a fastening nut so that it can be coupled to the center nozzle 2. Consequently, the center nozzle 2 fulfills a dual function in that, on the one hand, together with the gas nozzle 4, it forms the annular gap 17 and, on the other hand, it serves as a fastening means during the installation of the torch body 10 in order to fasten the center nozzle 2 to the torch body 10. Within the scope of this fastening, the gas nozzle 4 is pulled over the center nozzle 2 until an internal thread 24 of the gas nozzle 4 engages with an external thread 25 of the torch body 10. The annular surface 23 forms a stop of the center nozzle 2 against which the gas nozzle 4 exerts a force in the direction of the torch body 10 when the nozzles are being screwed in place.

The outlet opening 7 of the center nozzle 2 can have a diameter of approximately 13 mm² to 20 mm², especially about 16 mm². The sum of the cross sections of the secondary flow channels 5 of the gas nozzle 4 can amount to approximately 18 mm² to 22 mm², especially about 20 mm². In the present example, for instance, eight secondary flow channels 5 are provided, although this number can vary.

In order to ensure a particularly advantageous distribution of the shielding gas, the ratio of the diameter of the outlet opening 7 to the sum of the cross sections of the secondary flow channels 5 can be similar, especially about 4:5.

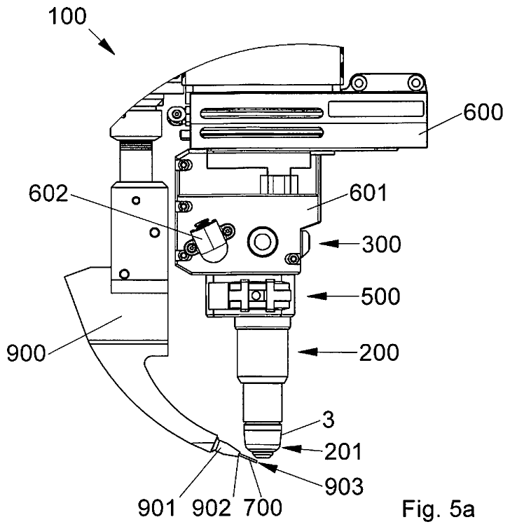

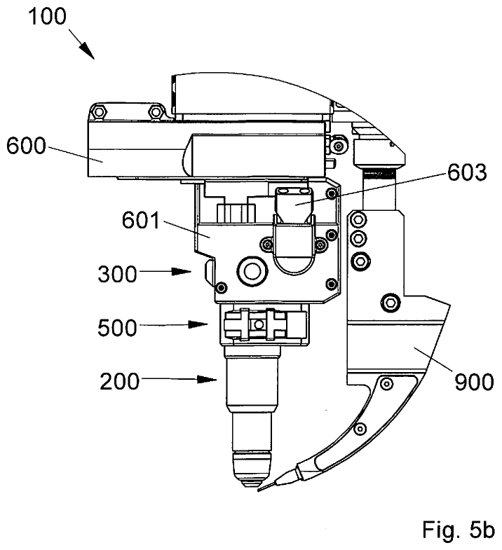

FIGS. 5a to 7 show a joining device 100 with a machine-controlled torch 200, 200′ having, for example, a torch body 10 as described above, for generating an arc between a non-consumable electrode 1 arranged therein, especially a tungsten electrode, and the workpiece 11.

A torch changing device 300 is provided for replacing the torch 200 with a new torch 200′. In this context, a replaceable torch 200 can have a replacement interface.

A tactile seam tracking system 900 has a position transducer 901 which is arranged at a certain distance from the torch 200 and so as to be movable relative to the workpiece 11. The position transducer 901 ascertains the momentary position of a measuring sensor installed on the front end of the position transducer 901, said measuring sensor moving along the joining site of the workpieces 11 that are to be joined together.

Within the scope of a movement relative to the position transducer 901, the torch 200 can be moved into at least one working position 500 for thermally joining the workpiece 111 and into a replacement position 400 for replacing the torch 200 that is to be replaced by a new torch 200′.

As FIG. 1 also shows, due to the structural dimensions of the thermal joining device 100, a distal end 903 of the position transducer 901, which normally is configured so as not to be movable, is arranged very close to, that is to say, just a few millimeters away from, the front end 201 of the torch 200. For this reason, the torch 200, 200′ and the position transducer 901 might collide when the torch is being replaced.

The position transducer 901 can have a feed device 904 with an outlet opening 902 through which a filler material 700 for welding or soldering can be moved into the immediate vicinity of the torch head. The filler material 700 can be, for instance, welding wire or soldering wire. The wire can be fed potential-free as a cold wire or non-isolated as a hot wire.

Consequently, during the replacement of a torch, the torch 200, 200′ and the filler material 700 might collide, for instance, due to a filler wire that has not been retracted completely. Such collisions can damage the torch 200.

Therefore, the tactile seam tracking system 900 fulfills a dual function. On the one hand, it has the position transducer 901 to ascertain the momentary position of the torch 200 relative to the seam that is to be welded or soldered. On the other hand, the seam tracking system 900 also comprises the feed device 904 that serves to feed the filler material.

FIG. 5a shows the joining device in a side view, FIG. 5b shows another side view. In the working position 500 depicted in both FIGS. 5a and 5b, the tactile seam tracking system 900 moves along a seam that is to be welded or soldered. The torch 200 moves at a small distance or in the same position thereto and follows the seam tracking system 900, thus defining a prescribed working direction of the torch 200.

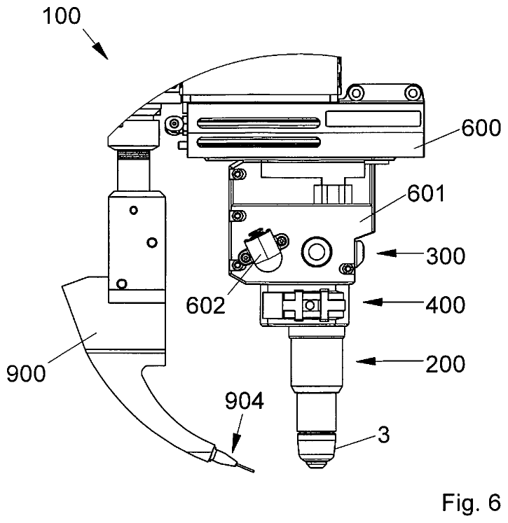

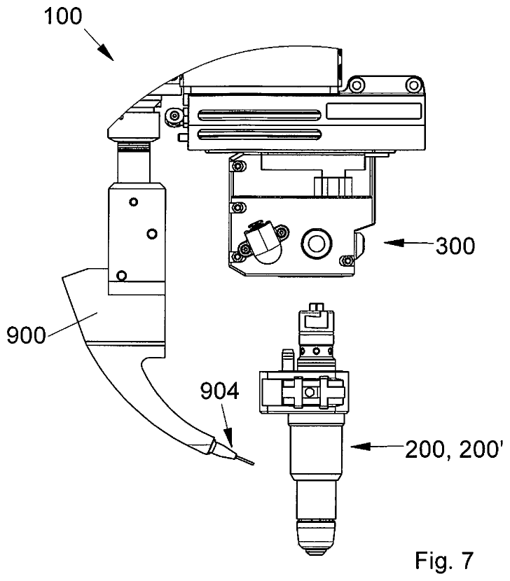

In the replacement position 400 as shown in FIGS. 6 and 7, the distance between the torch 200 and the seam tracking system 900 is increased, particularly along the working direction, in that the torch 200 is moved away from the tactile seam tracking system 900 and counter to the working direction.

Once the distance between the torch 200 and the tactile seam tracking system 900 has increased, the torch 200 that is to be changed can be removed and replaced by a new torch 200′. FIG. 7 shows the device 100 with the removed torch 200, 200′. Means are provided such as, for instance, the gripper arms of a robot, so that the spent torch 200′ that is to be replaced can be uncoupled from the source of welding energy, especially from the lines for the shielding gas, for the electric energy and for the coolant. Then the torch 200′ is moved away from the tactile seam tracking system 900, for example, approximately in parallel to the longitudinal direction of the torch 200 towards a changer (not shown here), so that it can ultimately be removed without colliding with the seam tracking system 900.

In order to achieve the requisite distance between the torch 200 and the tactile seam tracking system 900, a movable carriage 600 for positioning the torch that has been coupled to the carriage can be provided in order to replace the torch 200 that is to be replaced with a new torch 200′. Such a torch is shown in FIGS. 5a to 7. In order to prevent the torch 200 and the feed device 904 from colliding, the torch 200 is moved by means of the carriage 600 in the direction of the changer and thus away from the feed device 904. The carriage 600 is necessary since the feed device 904 for the filler material 700 and the measuring sensor of the tactile seam tracking system 900 are arranged rigidly, that is to say, immovably, relative to the torch 200, so that this feed device 904 gets in the way during the procedure of replacing the torch 200 and, due to the very small distance to the torch 200, it might cause the torch 200 to collide and be damaged.

The carriage 600 can be powered electrically, pneumatically or hydraulically.

The carriage 600 has a torch holder 601 for holding the torch 200 and/or a coupling device 602 for coupling the line that conveys the shielding gas through the torch body 10 and/or a coupling device 603 for coupling the lines that convey the coolant and the welding energy as a so-called current-water cable through the torch body 10. The torch holder 601 ensures easy latching and unlatching, so that the replacement of the torch 200, 200′ can be carried out quickly and reliably.

The torch 200 can be moved between the working position 500 and the replacement position 400 and vice versa. It would also be possible for the torch 200 to be moved exclusively between these two positions. In order to attain a very high degree of precision of the welding or soldering processes, the control means has to allow the appertaining positions of the torch to be approached very precisely. In order to prevent imprecisions, the torch 200 can be locked at least in the working position 500 and/or in the replacement position 400.

### LIST OF REFERENCE NUMERALS

1 electrode
2 center nozzle
3 front nozzle
4 gas nozzle
5 secondary flow channel
6 cooling element
7 inner outlet opening
8 internal isolator
9 distal end
10 torch body
11 workpiece
12 cooling channels
13 gas outlet
14 main gas flow
15 secondary gas flow
16 outer outlet opening
17 annular gap
18 front end of the torch body
19 external isolation
20 longitudinal axis of the front nozzle
21 cylindrical section of the electrode
22 sharpened end of the electrode
23 annular surface
24 internal thread of the gas nozzle
25 external thread of the torch body
26 truncated cone plateau of the electrode
100 joining device
200 torch
200′ torch
201 front end of the torch
300 torch changing device
400 replacement position
500 working position
600 carriage
601 torch holder
602 coupling device for the shielding gas
603 coupling device for the coolant and for the welding energy
700 filler material
900 tactile seam guiding device
901 position transducer
902 outlet opening
903 distal end
904 feed device

1. A torch body (10) for thermally joining at least one workpiece (11) by arc welding or arc soldering, comprising:
a non-consumable electrode (1) arranged in the torch body (10) for generating an arc between the electrode (1) and the workpiece (11), and
an electrically potential-free front nozzle (3) defining a gas outlet (13) through which a shielding gas stream can flow out, the front nozzle (3) comprising a center nozzle (2), a gas nozzle (4), and at least one secondary flow channel (5) to divide the shielding gas stream into a main gas flow (14) and a secondary gas flow (15), wherein the secondary gas flow (15) surrounds the main gas flow (14) at the gas outlet (13) in an annular pattern.

2. The torch body (10) according to claim 1, wherein the front nozzle defines a longitudinal axis (20) and a circumference, and wherein several secondary flow channels (5) are arranged along the circumference of the front nozzle (3) at and are at an opening angle of 10° to 30° directed outwards relative to the longitudinal axis (20) of the front nozzle (3).

3. The torch body (10) according to claim 1, wherein the electrode (1) either forms a distal end (9) of the torch body (10) facing the workpiece (11) or is substantially flush with the distal end (9) of the torch body (10).

4. The torch body (10) according to claim 1, wherein the front nozzle (2) forms a distal end (9) of the torch body (10) facing the workpiece (11), and the electrode (1) is recessed relative to the distal end (9).

5. The torch body (10) according to claim 1, wherein the electrode (1) a substantially cylindrical section (21) and/or a sharpened end (22) facing the workpiece.

6. The torch body (10) according to claim 1, further comprising a cooling element (6) adapted to cool the torch body (10), wherein the cooling element (6) has cooling channels (12) for conveying a coolant.

7. The torch body (10) according to claim 1, wherein the front nozzle (3) is configured in two parts.

8. The torch body (10) according to claim 1, further comprising an internal electric isolator (8) adapted to electrically isolate the front nozzle (3) from the electrode (1).

9. The torch body (10) according to claim 1, wherein an annular gap (17) for equalizing and guiding the secondary gas flow (15) is formed between the center nozzle (2) and the gas nozzle (4).

10. The torch body (10) according to claim 1, wherein the at least one secondary flow channel (5) is formed in the center nozzle (2).

11. The torch body (10) according to claim 9, wherein the front nozzle (3) defines a longitudinal axis (20) and a circumference, and wherein the gas nozzle (4) at least partially overlaps the center nozzle (2) at the end of the outlet opening (16) of the at least one secondary flow channel (5) forming the annular gap (17) over the circumference.

12. (canceled)

13. (canceled)

14. The torch body (10) according to claim 1, wherein a ratio of the cross section of the outlet opening (7) to the sum of the cross sections of the secondary flow channels (5) is approximately 4:5.

15. The torch body (10) according to claim 1, wherein the gas nozzle (4) is configured as a fastening nut so that it can be coupled to the center nozzle (2).

16. A torch having a torch body (10) according to claim 1.

17. A method for thermally joining at least one workpiece (11), comprising:
arc welding or arc soldering using a torch body (10) with a non-consumable electrode (1) for generating an arc between the electrode (1) and the workpiece (11),
surrounding the electrode (1) with a shielding gas stream that flows out of a potential-free front nozzle (3) of the torch body, wherein the shielding gas stream is divided into a main gas flow (14) that directly surrounds the electrode (1) and a secondary gas flow (15) that exits from a front end (18) of the torch body (10), and wherein the secondary gas flow (15) surrounds the main gas flow (14) at the gas outlet (13) in an annular pattern.

18. A joining device (100) for thermally joining at least one workpiece (11) by arc welding or arc soldering, comprising:
a machine-controlled torch (200) for generating an arc between a non-consumable electrode (1) arranged therein and the workpiece (11),
a torch changing device (300) for replacing the torch (200) with a new torch (200′), a tactile seam tracking system (900) having a position transducer (901) that is arranged so as to be movable relative to the workpiece (11) and so as to be at a certain distance from the torch (200), wherein the torch (200) is coupled to the tactile seam tracking system (900), so that movement relative to the position transducer (901) moves the torch (200) either into at least one working position (500) for thermally joining the workpiece (11) or into a replacement position (400) for replacing the torch (200) with a new torch (200′).

19. The joining device (100) according to claim 18, further comprising a movable carriage (600) to which the torch (200) is coupled.

20. The joining device (100) according to claim 19, wherein the carriage (600) is powered electrically, pneumatically or hydraulically.

21. The joining device (100) according to claim 19 wherein the carriage (600) has a torch holder (601) for holding the torch (200) and one or both of either a coupling device (602) for feeding shielding gas and a coupling device (603) for feeding coolant and welding energy.

22. The joining device (100) according to claim 18, wherein the torch (200) is locked at least in the working position (500).

23. The joining device (100) according to, claim 18, wherein the torch (200) can be moved exclusively between the working position (500) and the replacement position (400), and vice versa.

24. The joining device (100) according to claim 18, wherein the seam tracking system (900) has an outlet opening (902) through which a filler material (700) for arc soldering or arc welding and/or additional shielding gas can be dispensed.

25. The joining device (100) according to claim 18, wherein a distal end (903) of the tactile seam tracking system (900) is positioned at or near a front end (201) of the torch (200).
